(19) United States
(12) Patent Application Publication
(10) Pub. No.: US 2010/0144962 A1
(43) Pub. Date: Jun. 10, 2010

(54) SHAPE MEMORY POLYMER AEROGEL COMPOSITES

(75) Inventors: Sadhan C. Jana, Fairlawn, OH (US); Mary Ann B. Meador, Cleveland, OH (US); Jason Patrick Randall, Akron, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/445,528

(22) PCT Filed: Oct. 26, 2007
(86) PCT No.: PCT/US07/22760

§ 371 Date: Feb. 2, 2010

Related U.S. Application Data
(60) Provisional application No. 60/854,838, filed on Oct. 27, 2006.

(51) Int. Cl. C08G 18/83; B29C 43/00; C08K 3/04

(52) U.S. Cl. 524/590; 525/453; 525/452; 264/331.19; 977/742

(57) ABSTRACT

The present invention relates to the synthesis of aerogel composites and utilizes shape-memory polyurethane cross-linkers as a method of improving the compressive and flexural load bearing capabilities of the aerogel composites. The shape memory polyurethane crosslinkers provide flexible connectors between the silica particle in the aerogel structure and can accept large compressive and flexural loads without breakage of the aerogel networks. In addition the shape memory properties of polyurethane cross-linkers offers additional advantages such as ease of storage in deformed state of the composites. In one embodiment, the present invention relates to shape memory polymer formulations that can be used specifically to obtain higher compressive and/or flexural strengths and smart material characteristics of crosslinked aerogel composites.

### RELATED APPLICATION DATA

This application claims priority to previously filed U.S. Provisional Patent Application No. 60/854,838, filed on Oct. 27, 2006, entitled “Shape Memory Polymer Aerogel Composites,” which is incorporated by reference herein in its entirety.

The present invention was made in the course of research and discussions with NASA support. The United States government may have certain rights to the invention or inventions herein.

### FIELD OF THE INVENTION

This invention generally relates to the synthesis of aerogel composites. In one embodiment, the present invention relates to shape memory polymer formulations that can be used to obtain higher compressive and flexural strengths and smart material characteristics.

### BACKGROUND OF THE INVENTION

Shape memory polymers have a wide range of technological applications, e.g., as deployable space structures, space curable composites, inflatable tubes, heat shrink tubes, breathable textiles, medical supplies, choke devices for automotive applications, actuators and sensors, stents, insulators, and packaging materials. A recent market survey detailed the worldwide sales of smart materials (including shape memory polymers) with piezoelectric, magnetostrictive, electrochromic, thermoresponsive, and electrostrictive applications growing substantially. The study also revealed a significant amount of shape-memory polymers being used in biomedical applications.

A polyurethane shape memory polymer was first reported in the patent literature in 1966. It was also found that chlorinated polybutene-1 foams and crosslinked polyethylene exhibited shape memory behavior, the latter are used as heat-shrinkable packaging or in the insulation of cables. These uses were followed by a series of patented inventions mainly in the area of polyurethanes. For example, polyurethane-diacrylate and polyurethane-polyallyl ester polyene exhibit shape memory effects in boiling water which has led to their use in surgical implants. Thermoset and thermoplastic polyurethane shape-memory polymers were developed as self-healing synthetic leather and paint. Shape memory polyurethane foams using 40 different compositions of diisocyanates, polyol, chain extenders, and blowing agent, were reported with molar ratios in the range of (1.1-2.0):1.0:(0.10-1.0) for diisocyanate, polyol, and chain extender being recommended to obtain the best performance. These shape memory polymers found applications in transparent lenses and containers, as heat insulator foams, and as ingredients for woven and non-woven fabrics. In this same manner Hayashi et al., developed urethane-based transparent shape memory films for packaging and these methods were published by Hayashi in 1993 and by Hayashi et al. in 1995. The state of the art at the time established that polyurethanes must have a soft segment glass transition (T_{g}) near room temperature. In addition, the ratio of elastic modulus in the glassy and rubbery states must be at least 20 to create efficient shape recovery from the deformed state. The thinking then proposed the ratio of elastic modulus in glassy and rubbery states to be controllable by the hard segment content.

Kim et al. published a series of articles further defining shape memory thermoplastic polyurethanes. Kim found that a high ratio of glassy to rubbery modulus—needed for shape-memory effect—can be obtained with the use of crystalline soft segments (e.g., polycaprolactone diols), ionomers (e.g., dimethylpropionic acid), or mesogenic moiety (e.g., hydroxy-substituted biphenyls). Their research also detailed that ionomers and mesogenic moiety increased strength and recovery strains. In addition, this group established that amorphous polyurethanes exhibit shape-memory effects if allophanate type crosslinked networks are allowed to form. Crosslinked networks were found to be more effective in fixing shape when present in soft segments, while crosslinked networks present in hard segments provided higher shape recoverability. Lee et al. found a 30-45% hard segment content optimum for shape-memory effects in thermoplastic polyurethanes. Another application utilized as catheters, shape memory urethane polymers having a T_{g} (glass transition temperature) near human body temperature.

Other specialized applications of shape memory polymers involve the coating of a web take up roll to provide grip as a function of changes in modulus with temperature, providing precisely actuated, micrometer sized release devices in therapeutics and shape memory polyurethanes prepared from silicone-based macrodiols being used as stents and suture anchors. Wei et al. presented a comprehensive review of shape-memory materials and their hybrid composites including those of shape-memory polymers.

Lendlein et al. studied the influence of crystallinity on shape-memory effects of an AB-type copolymer of n-butylacrylate and oligo(ε-caprolactone)dimethacrylate and found that shape recovery ratio increases and strain fixity decreases with a reduction in the degree of crystallinity coming from the caprolactone. The same authors developed biodegradable shape-memory polymers from oligo(ε-caprolactone)diol and oligo(p-dioxanone)diol for implant and suture applications. An extensive review of shape memory polymers is presented by Lendlein and Kelch. The cis/trans content of vinylene groups was used by Liu et al. to tune the transition temperature of crystalline crosslinked polycyclooctene shape memory polymers. These materials recovered to a stress-free shape within 1 second upon immersion into hot water. Rousseau and Mather studied shape memory effects of liquid crystalline elastomers, while Liu and Mather studied shape memory effects in polymethylmethacrylate.

Liang et al. used the formulation of Hayashi and developed shape-memory polyurethane composites of chopped and woven glass fibers using a prepreg method. These composites did not exhibit any shape-memory to tensile deformation in the direction of fibers, although some degree of bending deflection was recovered. The unfilled polymer showed a shape recovery stress of 4 MPa at 400% initial tensile elongation which is much smaller compared to a 500 MPa stress for shape memory alloys at 8% initial elongation. Ohki et al. mixed 10-20 wt % chopped glass fiber in shape-memory polyurethanes to obtain an increase in tensile strength and an improved resistance to crack propagation upon cyclic loading. Gall et al. observed that silicon carbide (SiC) nanoparticles stored compressive stress during deformation and released it during heated strain recovery of epoxy-based shape memory polymer nanocomposites. In addition, the elastic modulus of nanocomposites exhibited a 3-fold increase with the addition of 40 wt % SiC; the unconstrained strain recovery from 180° bending did not depend on SiC content if it was less than 40 wt %. (In this case, SiC particles did not have any interactions with polymer chains.) Another study detailed that carbon nanoparticles and bound moisture can reduce glass transition temperature of conductive shape memory polyurethanes composites. Electro-active shape memory polyurethane composites of carbon black and carbon nanotubes have also been developed.

Silica aerogels are among the world's lightest solids, with density values ranging between 0.3-800 mg/cc. In conjunction, silica aerogels exhibit extremely low values of thermal conductivity due to their highly porous structures. Consequently, aerogels are an excellent choice for thermal insulation, especially in aerospace applications where weight is a premium. Recently, a silica aerogel material was used as insulation around the battery packs of the Sojourner Mars Rover.

A few key issues must be overcome in order to broaden the scope of use of silica aerogels in strategic applications such as defense and space missions. One major concern involves fragility since native silica aerogels of average density can be crushed by applying approximately 31 kPa of stress. As such, the current focus in research is to develop methods to reinforce the aerogel networks without compromising the given advantages of low density and low thermal conductivity.

In the chemical approach, aerogel networks are reinforced by crosslinking with epoxies or urethanes. A majority of the silica particles in aerogel networks carry —OH groups due to the manner they are prepared from the hydrolysis of a native aerogel. The —OH groups react with isocyanates to produce urethane crosslinks. This method has created an aerogel 300 times stronger than its native state, with only a factor of 3 times the increase in density.

Additional work followed with —OH groups being modified by aminosilanes to convert into —NH₂ end groups, which in turn can be used to crosslink the aerogel networks by epoxy and isocyanates. Although these can be successful in increasing the strength over native aerogels, such crosslinking schemes pose many difficulties. First, the aerogel networks must be grown into the same final form as that of the article and then crosslinked, a process which is not always practical. Second, the crosslinked aerogel must be handled carefully as the strength, although higher than the native aerogel, is not large enough to withstand the typical stresses encountered in standard handling steps. The use of shape memory polyurethane crosslinkers alleviates these concerns and offers a practical method for preparation of the aerogel materials.

Shape memory polymers have arisen as a promising new material for a wide range of applications. In comparison shape memory polymers exhibit advantages over the use of shape memory alloys. The first recognized advantage of shape memory polymers being cost. Second, shape memory polymers can reach higher deformations than shape memory alloys. Third, a shape memory polymer is capable of changing its shape in response to a set of external stimuli, for example pH, electric current, magnetic induction, and heating. Usually, one or more chemical constituents respond to the external stimuli, while others contribute to the desired properties. Finally, shape memory polymers can be shaped into complex articles using conventional manufacturing schemes.

### SUMMARY OF THE INVENTION

The present invention relates to the synthesis of aerogel composites and utilizes shape-memory polyurethane cross-linkers as a method of improving the compressive and flexural load bearing capabilities of the aerogel composites. The shape memory polyurethane crosslinkers provide flexible connectors between the silica particle in the aerogel structure and can accept large compressive and flexural loads without breakage of the aerogel networks. In addition the shape memory properties of polyurethane cross-linkers offers additional advantages such as ease of storage in deformed state of the composites. In one embodiment, the present invention relates to shape memory polymer formulations that can be used specifically to obtain higher compressive and/or flexural strengths and smart material characteristics of crosslinked aerogel composites.

In one embodiment, the present invention relates to a process for forming a shape memory polymer composite comprising the steps of: providing a shape memory polyurethane prepolymer or extended polymer chain having (a) a number average molecular weight between 1000 and 120,000, (b) a glass transition temperature above 20° C. or a crystalline melting temperature above 20° C., (c) one or both ends of the prepolymer chain forming a hard segment and containing isocyanate groups, modified diisocyanate with flexible chain structures, urethane or urea, and (d) a chain middle containing crystalline or glassy soft segments; and reacting the polymer with —OH or —NH₂ functional groups on silica surfaces to crosslink the structure.

In yet another embodiment the present invention relates to a shape memory polymer composite made by the process of forming the shape memory polymer composite comprising the steps of: providing a shape memory polyurethane prepolymer or extended polymer chain having (a) a number average molecular weight between 1000 and 120,000, (b) a glass transition temperature above 20° C. or a crystalline melting temperature above 20° C., (c) one or both ends of the prepolymer chain forming a hard segment and containing isocyanate groups, modified diisocyanate with flexible chain structures, urethane or urea, and (d) a chain middle containing crystalline or glassy soft segments; and reacting the polymer with —OH or —NH₂ functional groups on silica surfaces to crosslink the structure.

In still yet another embodiment the present invention relates to a method of forming a shape memory polymer aerogel composite comprising the steps of: using a polyurethane prepolymer or chain extended polymer chain with hard segments and crystalline or glassy soft segments in the chain middle to crosslink aerogels, plasticizing the soft segments using supercritical carbon dioxide or supercritical nitrogen, deforming the composite in the supercritical carbon dioxide or supercritical nitrogen, removing the composite from the supercritical carbon dioxide or supercritical nitrogen in a deformed state, and allowing the composite to return to a part or whole of its original shape allowing the composite to return to a part or whole of its original shape by a subsequent exposure to the supercritical carbon dioxide or supercritical nitrogen or by heat.

In another embodiment the present invention relates to a method of forming a shape memory polymer composite comprising the steps of: using a polyurethane prepolymer or chain extended polymer chain with hard segments and crystalline or glassy soft segments in the chain middle, the polyurethane prepolymer or chain extended polymer chain being predispersed with carbon nanotubes and carbon nanofibers, plasticizing the soft segments using supercritical carbon dioxide or supercritical nitrogen, deforming the composite in the supercritical carbon dioxide or supercritical nitrogen, removing the composite from the supercritical carbon dioxide or supercritical nitrogen in the deformed state, and allowing the composite to return to a part or whole of its original shape by exposure to the supercritical carbon dioxide or supercritical nitrogen, to heat, to a laser light, to infrared light or to a suitable energy producing device.

### BRIEF DESCRIPTION OF THE DRAWINGS

FIG. 1 details a shape memory polyurethane chain connecting two silica particles;

FIG. 2 details an interconnected crosslinked network of silica particles;

FIG. 3 details the steps involved in the shape memory functions based on compressive deformation of aerogel networks crosslinked with shape memory formulation; and

FIG. 4 details a schematic showing deformation and shape-recovery cycle with εₘ being the maximum compressive strain, σₘ being the maximum compressive stress, T_{g} being the glass transition temperature, Tₘ being the melting temperature, T_{L} being the lower temperature (typically room temperature), T_{H} the temperature the material at which was heated, and σ_{R} being the compressive stress at shape recovery.

### DETAILED DESCRIPTION OF INVENTION

The present invention relates to the synthesis of aerogel composites and utilizes shape-memory polyurethane cross-linkers as a method of improving the compressive and flexural load bearing capabilities of the aerogel composites. The shape memory polyurethane crosslinkers provide flexible connectors between the silica particle in the aerogel structure and can accept large compressive and flexural loads without breakage of the aerogel networks. In addition the shape memory properties of polyurethane cross-linkers offers additional advantages such as ease of storage in deformed state of the composites. In one embodiment, the present invention relates to shape memory polymer formulations that can be used specifically to obtain higher compressive and/or flexural strengths and smart material characteristics of crosslinked aerogel composites.

Polyurethanes have two basic chemical structures—a hard and a soft segment. The hard segment 8 being a “memory kernel”, while the soft segment 6 is a deformable component. It is conceivable that the soft segment 6 remains in a glassy or crystalline state at room temperature and is then converted into an amorphous state above a transition temperature, that temperature typically being 10-20° C. above room temperature. The hard segments 8 may have an additional set of glass transition and/or melting temperatures, with these temperatures much higher than those of the soft segments 6. The typical glass transition and/or melting temperatures for the hard segments 8 being in the 100-200° C. range. During a standard shape memory test, the soft segments 6 are deformed above the transition temperature and the state of deformation is then locked by rapid freezing. The original shape and size is recovered by heating the deformed sample above its transition temperature. The heating allows the deformed soft segment domains to become mobile again, leading to chain rearrangement and recovery of the original shape.

Silica aerogels, crosslinked with hexamethylene diisocyanates, produce an acceptable material for thermal insulation in a variety of applications. However, these materials lack adequate compressive and flexural strengths. This lack of strength produces limitations such as the ability to manufacture into complex forms, the ability to easily handle the material, and the ability to use in broader scope of applications such as in space suit and as thermal insulation in space shuttle applications. This led to a need to develop alternative crosslinkers which would improve the compressive and flexural load bearing capabilities and led to the idea of using shape-memory polyurethanes as crosslinkers. The shape-memory polyurethanes provide flexible connectors between the silica particles in the aerogel structure and can accept a large compressive or flexural load without breakage of the aerogel networks. This creates opportunity in many thermal applications, such as insulation foams for space shuttles, foam layers in space suits, and so forth, areas which cannot be served with the current technology. In addition, the shape memory properties of polyurethane crosslinkers can offer additional advantages in such areas as ease of storage. The articles can be compressed to much smaller sizes above a transition temperature and stored with the original shape and size being recovered by heating the articles above the transition temperature after deployment.

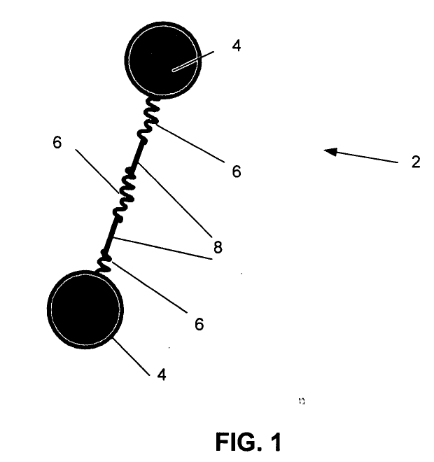

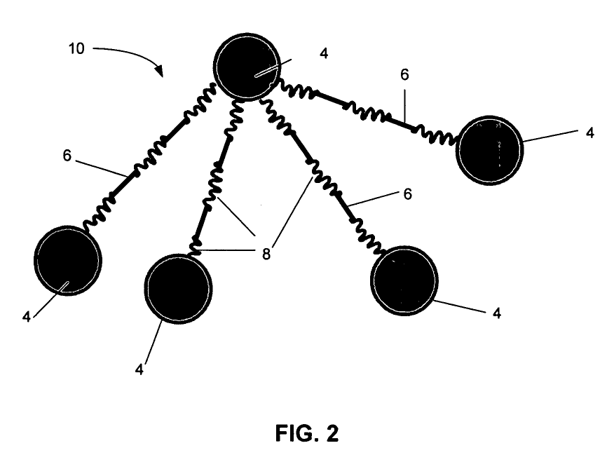

The invention synthesizes aerogel composites. In one embodiment, the present invention relates to shape memory polymer formulations that can be used to obtain higher compressive strengths and smart material characteristics. The shape memory aerogels using shape memory polyurethane prepolymers of number average molecular weight 1,000-120,000 and with glass transition or crystalline melting temperature above room temperature. These chains carry isocyanate groups on both ends and contain glassy or crystalline soft segments 8. Optionally, modified diisocyanates with flexible chain structures and molecular weights of at least 1,000 can be used. The prepolymer or modified diisocyanates react with one or more —OH or —NH₂ functional groups present on the surface of silica particles 4 to crosslink and yield an aerogel structure. The primary structure of the crosslinked aerogel 2 is a pair of silica particles 4 connected by a flexible, shape memory polyurethane chain, as depicted in FIG. 1. The hard segment 6 being a urethane —NH—COO— or urea —NH—CO—NH— structure, while the soft segment 8 is in a glassy or crystalline state. In another embodiment, one or more silica particles 4 are connected to multiple shape memory polyurethane chains, which leads to an interconnected networks 10 of silica particles 4 (FIG. 2).

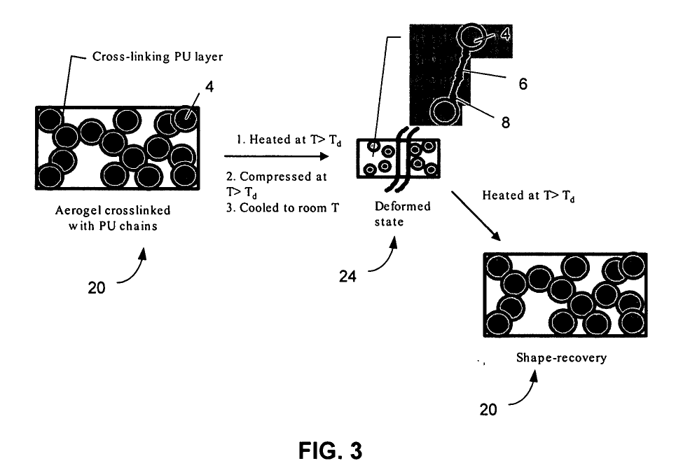

The shape memory function of crosslinked aerogels is created by following the steps described below and detailed in FIG. 3. The hard 8 and soft 6 segments are used to trigger the shape-memory function. The crystalline soft segment 6 melts at Tₘ, a temperature above room temperature. In one embodiment this temperature Tm is between about 50° C. and 60° C. The soft segment 6 glass transition temperature T_{g} or melting temperature Tm is also greater than room temperature. The hard segment 8 melting temperature is much higher than Tₘ and Tg. In one embodiment this temperature being between about 180° C. and 190° C. The composite is heated to a temperature T_{d}, T_{d} being a temperature greater than the soft segment 8 Tₘ or T_{g}, the composite is then compressed to a deformed state, 24, and subsequently cooled to room temperature. At this point, the compressive force is withdrawn. The composite material can be deployed in its particular field of application in this form 24. After deployment, the original shape 20 is recovered by heating the composite to a temperature above T_{c} or T_{g}. The use of a prepolymer with a molecular weight of at least 2000, or even at least 1000 prevents breakage of the composite under compressive load, especially at temperatures above Tm and Tg. This invention also includes aerogels with amine surface modifiers, aerogels dried under different conditions, and aerogels in various shape memory formulations.

Aerogels and crosslinked aerogels possess poor thermal conductivity, therefore, the particular heating protocol of FIG. 3 is one means to address this shortfall. Small quantities of carbon nanotubes or carbon nanofibers are predispersed in the aerogel during its synthesis or during the crosslinking with polyurethanes. The nanotubes and nanofibers absorb energy from a device. In various embodiment this device produces heat, is a laser light, is an infrared light or is a suitable energy producing device. In one embodiment this energy absorption is used as a heat source while the crosslinked aerogels are exposed to laser radiation. The crystalline soft segments therefore melt due to the local heating in the vicinity of carbon nanotubes or nanofibers.

In another embodiment, the crystalline or glassy soft segments 8 can be plasticized using supercritical carbon dioxide or nitrogen and subsequently these segments are deformed under stress. The deformed materials are taken out of the supercritical liquid chamber to retain the deformed state. The original shape is recoverable by exposing the material again to the supercritical liquid.

In another embodiment, crosslinked aerogel composites are prepared with carbon nanotubes and nanofibers. The crystalline or glassy soft segments 8 can be plasticized using supercritical carbon dioxide or nitrogen and subsequently these segments are deformed under stress. The deformed materials are taken out of the supercritical liquid chamber to retain the deformed state. The original shape is recoverable by exposing the material to the laser, infra-red radiation, or some other suitable heating means.

The key advantage of shape memory silica aerogels involves their ease of deployment for the final part. Care must be taken in handling the crosslinked silica aerogel monoliths and the aerogel must be molded to size during the initial crosslinking step. Native silica aerogels are even more fragile and require additional care. The aerogel articles based on shape memory polyurethanes can be stretched, bent, or compressed to produce various shapes to meet the needs of the actual application. As an insulation material, a shape memory aerogel part in compressed form can be deployed without a precise fitting into the mold gap. The part later expands inside the mold gap upon heating and completely fills the area. Another advantage involves the aerogel article being self-repairing in minor damage situations as the aerogel is heated locally to undergo thermal transition and redistribution of polymer over small gashes in the material. Another advantage of the current invention is the ease with which articles of complicated shapes can be molded from a stock of flat crosslinked aerogel panels. This is aided by a softening of the thermoplastic polyurethane building blocks upon heating.

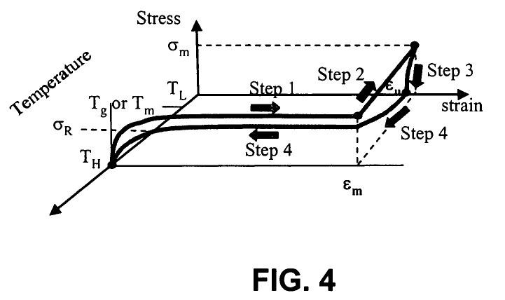

A final representation of the cyclic loading and unloading forces the shape-memory polymers are subjected to, is depicted in FIG. 4. FIG. 4 details a schematic showing deformation and shape-recovery cycle with εₘ being the maximum compressive strain, σₘ being the maximum compressive stress, T_{g} being the glass transition temperature, Tₘ being the melting temperature, T_{L} being the lower temperature (typically room temperature), T_{H} the temperature the material at which was heated, and σ_{R} being the compressive stress at shape recovery. In Step 1, tensile, compression, and bending forces, or their combinations are applied to the specimen to exert a maximum stress σₘ at temperature T_{H}, a temperature above the glass transition (T_{g}) or melting (Tₘ) temperature. The deformed polymer is cooled to T_{L}, a temperature below the glass transition and melting temperatures, T_{L}<T_{g} (or Tₘ) (Step 2). The polymer then undergoes small change of strain (εₘ-εᵤ) after the stress is withdrawn (Step 3). Shape recovery occurs as the polymer is heated again to T_{H}. A maximum recovery stress σ_{R} is observed.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A process for forming a shape memory polymer composite comprising the steps of:
providing a shape memory polyurethane prepolymer or extended polymer chain having
(a) a number average molecular weight between 1000 and 120,000,
(b) a glass transition temperature above 20° C. or a crystalline melting temperature above 20° C.,
(c) one or both ends of the prepolymer chain forming a hard segment and containing isocyanate groups, modified diisocyanate with flexible chain structures, urethane or urea, and
(d) a chain middle containing crystalline or glassy soft segments; and
reacting the polymer with —OH or —NH₂ functional groups on silica surfaces to crosslink the structure.

2. The process of claim 1 wherein:
the crystalline or soft segment has a melting temperature greater than 20° C.;
the crystalline or soft segment has a glass transition temperature greater than 20° C.; and
the one or both ends of the prepolymer chain forms a hard segment having a melting temperature greater than or equal to 100° C.

3. The process of claim 2 further comprising:
heating the polymer composite to a temperature greater than the melting temperature of the soft segment or the glass transition temperature of the soft segment;
compressing or bending the polymer to a deformed state;
cooling the polymer; and
withdrawing the compressive or bending force after the cooling stage is complete.

4. The process of claim 3 further comprising:
placing the deformed polymer into a second area;
heating the polymer to a temperature greater than the soft segment melting temperature or soft segment glass transition temperature; and
recovering a part or the whole of the original shape of the composite.

5. The process of claim 2 wherein carbon nanotubes are predispersed in the prepolymer or chain extended polymer.

6. The method of claim 1 wherein:
the prepolymer or chain extended polymer is predispersed with carbon nanotubes;
the nanotubes absorb energy from a laser beam, infra red source or any other suitable energy producing device; and
the crystalline soft segments melt in the vicinity of the carbon nanotubes.

7. The method of claim 1 wherein:
the prepolymer or chain extended polymer is predispersed with carbon nanotubes;
the nanotubes absorb energy from a laser beam, infra red source, laser light or any other suitable energy producing device; and
the glassy soft segment undergoes glass transition into rubbery state in the vicinity of the carbon nanotubes.

8. A method of forming a shaper memory polymer aerogel composite comprising the steps of:
using a polyurethane prepolymer or chain extended polymer chain with hard segments and crystalline or glassy soft segments in the chain middle to crosslink aerogels;
plasticizing the soft segments using supercritical carbon dioxide or supercritical nitrogen;
deforming the composite in the supercritical carbon dioxide or supercritical nitrogen;
removing the composite from the supercritical carbon dioxide or supercritical nitrogen in a deformed state; and
allowing the composite to return to a part or whole of its original shape by a subsequent exposure to the supercritical carbon dioxide or supercritical nitrogen or by heat.

9. A method of forming a shape memory polymer composite comprising the steps of:
using a polyurethane prepolymer or chain extended polymer chain with hard segments and crystalline or glassy soft segments in the chain middle, the polyurethane prepolymer or chain extended polymer chain being predispersed with carbon nanotubes and carbon nanofibers;
plasticizing the soft segments using supercritical carbon dioxide or supercritical nitrogen;
deforming the composite in the supercritical carbon dioxide or supercritical nitrogen;
removing the composite from the supercritical carbon dioxide or supercritical nitrogen in the deformed state; and
allowing the composite to return to a part or whole of its original shape by exposure to the supercritical carbon dioxide or supercritical nitrogen, to heat, to a laser light, to infrared light or to a suitable energy producing device.
